(19) United States
(12) Patent Application Publication
(10) Pub. No.: US 2017/0328330 A1
(43) Pub. Date: Nov. 16, 2017

(54) HYBRID ELECTRIC VEHICLE ENGINE CRANKING

(71) Applicant: Ford Global Technologies, LLC, Dearborn, MI (US)

(72) Inventors: Jeremy MOORE, Ypsilanti, MI (US); Mark J. FERREL, Brighton, MI (US)

(21) Appl. No.: 15/155,765

(22) Filed: May 16, 2016

(51) Int. Cl. F02N 11/08; F02N 11/04; F02N 15/02; B60K 6/46; B60K 6/26

(52) U.S. Cl. CPC F02N 11/0866; B60K 6/46; B60K 6/26; F02N 11/04; F02N 15/022; B60K 2006/268; B60Y 2200/92; B60Y 2300/192; F02N 2200/061; Y10S 903/903; B60Y 2300/63

(57) ABSTRACT

A system for a vehicle includes an electric machine configured to transfer power between an engine and traction battery, an auxiliary battery electrically connected with and isolated from the traction battery, and a controller programmed to, after receiving an engine start request, initiate an engine start using the batteries in response to available traction battery power being below a threshold, and initiate the engine start using the traction battery but not the auxiliary battery otherwise.

### TECHNICAL FIELD

The present disclosure relates to systems and methods for supplying power to an engine of a vehicle under predetermined operating conditions.

### BACKGROUND

A powertrain system of a hybrid electric vehicle (HEV) may include an internal combustion engine. The powertrain system may have an engine starting mode for starting (or cranking) the engine under various vehicle operating conditions. Quality metrics for starting the engine may include, but are not limited to, quickness, smoothness, noise acoustical range, effect on other vehicle systems and components, and so on.

Cold temperatures may increase friction of engine lubricants and cranking the engine at a time when engine temperature or ambient temperature is below a threshold may use more energy. Engines designed with variable valve timing for reduced noise vibration and harshness (NVH) may have lower internal pressure than conventional engines and may use more energy during cranking.

### SUMMARY

A system for a vehicle includes an electric machine configured to transfer power between an engine and traction battery, an auxiliary battery electrically connected with and isolated from the traction battery, and a controller programmed to, after receiving an engine start request, initiate an engine start using the batteries in response to available traction battery power being below a threshold, and initiate the engine start using the traction battery but not the auxiliary battery otherwise.

A method for a vehicle includes after receiving an engine start request, initiating by a controller an engine start using a traction battery and an auxiliary battery electrically connected with and isolated from the traction battery in response to available traction battery power being below a threshold, and initiating the engine start using the traction battery but not the auxiliary battery otherwise.

A system for a vehicle includes an electric machine configured to be selectively coupled to an engine via a clutch, traction and auxiliary batteries electrically isolated from each other, and a controller programmed to, in response to receiving an engine start request while available traction battery power is below a threshold, operate the traction and auxiliary batteries at a same time to power the electric machine to start the engine.

### BRIEF DESCRIPTION OF THE DRAWINGS

FIG. 1 is a block diagram of a hybrid electric vehicle (HEV) illustrating a typical drivetrain and energy storage components;

FIG. 2 is a block diagram illustrating a powertrain system for starting an engine of the HEV using a traction battery;

FIG. 3 is a block diagram illustrating a powertrain system for starting the engine using an auxiliary battery;

FIG. 4 is a block diagram illustrating a powertrain system for starting the engine using the traction and auxiliary batteries; and

FIG. 5 is a flowchart illustrating an algorithm for starting the engine using the traction and auxiliary batteries.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

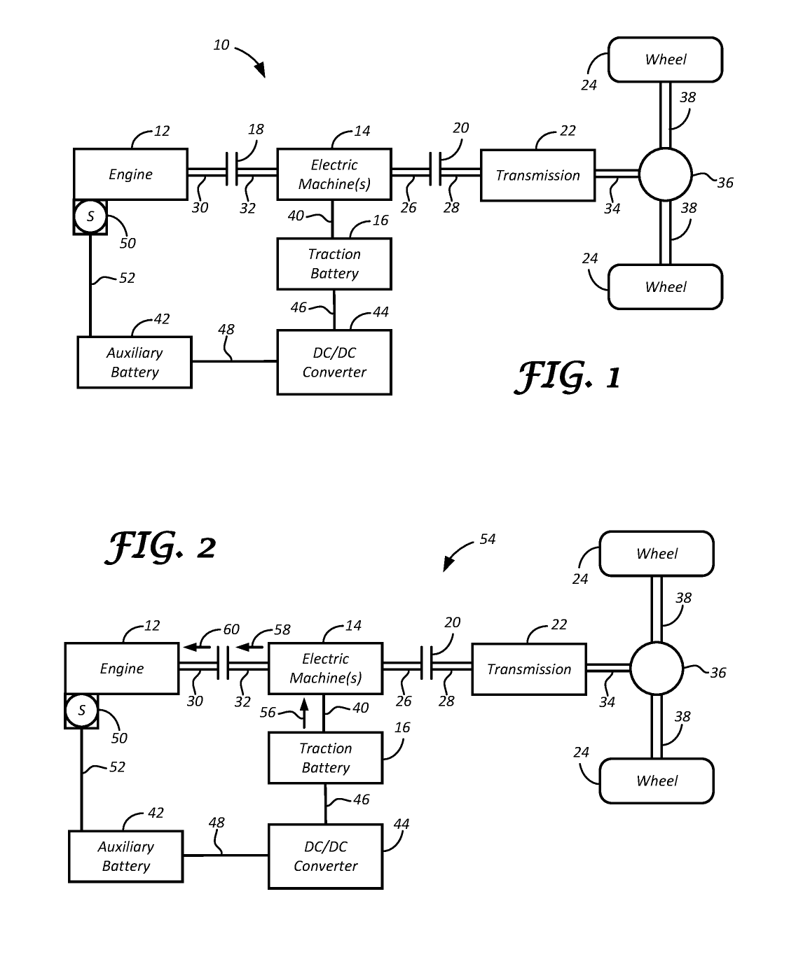

Referring now to FIG. 1, an exemplary powertrain system 10 for a hybrid electric vehicle (hereinafter vehicle) is shown. The powertrain system 10 includes an engine 12, one or more electric machines such as an electric motor and generator 14 (otherwise referred to as a “motor”), a traction battery 16, a disconnect clutch 18, a torque converter 20, and a multiple-ratio automatic transmission 22. The powertrain system 10 further includes a hybrid powertrain controller (not shown) configured to control operation of one or more components of the powertrain system 10.

The engine 12 and the motor 14 are drive sources for the vehicle. The engine 12 is connectable to the motor 14 through the disconnect clutch 18, such as, for example, via an engine output shaft 30 connectable to a motor input shaft 32, whereby the engine 12 and the motor 14 may be connected in series. The motor 14 is connected to the torque converter 20. The torque converter 20 is connectable to the engine 12 via the motor 14, such as, for example, when the engine 12 is connected to the motor 14 via the disconnect clutch 18. In one example, a motor output shaft 26 may be connected to an impeller of the torque converter 20.

The torque converter 20 is further connected to the transmission 22. In one example, a turbine of the torque converter 20 may be connectable to a transmission input shaft 28. The transmission 22 is connected to a differential 36 via a transmission output shaft 34 and drive wheels 24 are connected to the differential 36 through respective axles 38. The driving force applied from the engine 12 and/or the motor 14 is transmitted through the torque converter 20 and the transmission 22 to the drive wheels 24 thereby propelling the vehicle.

The transmission 22 may include planetary gear sets having a plurality of friction elements selectively engageable to achieve multiple gear ratios. The friction elements may be controllable through a shift schedule that connects and disconnects certain elements of the planetary gear sets to control a ratio between the transmission output torque and the transmission input torque. In one example, the transmission 22 may be automatically shifted from one ratio to another based on the needs of the vehicle.

In an example arrangement, the engine 12 may be a primary source of power for the powertrain system 10. The engine 12 may be an internal combustion engine, such as a gasoline, diesel, or natural gas powered engine. The engine 12 generates an engine torque that is supplied to the motor 14 when the engine 12 and the motor 14 are connected via the disconnect clutch 18. To drive the vehicle with the engine 12, at least a portion of the engine torque passes from the engine 12 through the disconnect clutch 18 to the motor 14 and then from the motor 14 through torque converter 20 to the transmission 22.

The traction battery 16 in some arrangements may be a secondary source of power for the powertrain system 10. The traction battery 16 may comprise a plurality of battery cells (not shown), e.g., electrochemical cells, electrically connected to a plurality of connectors and switches enabling and disabling the supply and withdrawal of electric energy to and from the battery cells. The plurality of connectors and switches may be electrically operated switches, relays, or other electric, electronic, or electromagnetic components configured to selectively establish, interrupt, or divert current flow between one or more portions of the traction battery 16 and other vehicle components. An example of an electrically controlled switch configured to operate in an HEV is a high voltage contactor.

In one example, the traction battery 16 may include a battery controller (not shown) configured to control the plurality of connectors and switches, e.g., contactors. In such an example, the battery controller may command one or more of the plurality of contactors to open or close connecting or disconnecting the traction battery 16 from other vehicle components. The battery controller may be electrically connected to and in communication with one or more other vehicle controllers, such as, but not limited to, a body controller, a climate control controller, a brake controller, and so on, and may command one or more contactors to open or close in response to receiving a signal from the other vehicle controllers. In an example, the battery controller may be in communication with the hybrid powertrain controller and may command the contactors to open or close in response to receiving a signal from the hybrid powertrain controller.

The battery controller may be further configured to receive signal from one or more battery and vehicle sensors, such as, but not limited to, battery voltage sensor, battery current sensor, battery temperature sensor, ambient temperature sensor, and so on. The battery controller may command one or more contactors to open or close in response to receiving a signal from the one or more battery and vehicle sensors. While the traction battery 16 is described herein as including electrochemical cells, other types of energy storage device implementations, such as capacitors, are also contemplated.

The traction battery 16 is electrically connected to the motor 14 through wiring 40 and energy stored in the traction battery 16 can be used by motor 14. In one example, the motor 14 may be electrically connected to an inverter (not shown) providing bi-directional energy transfer between the motor 14 and the traction battery 16. When the motor 14 operates in a motor mode, the inverter may convert high voltage direct current (DC) output provided by the traction battery 16 to a three-phase alternating current (AC) as may be required for proper functionality of the motor 14. When the motor 14 operates in a regenerative mode, the inverter may convert the three-phase AC output from the motor 14 acting as a generator to the DC input required by the traction battery 16.

In addition to providing energy for propulsion, the traction battery 16 may provide energy for other vehicle electrical systems, such as one or more high-voltage loads, e.g., compressors and electric heaters. The traction battery 16 may be further configured to provide energy to a low-voltage DC supply, such as an auxiliary battery 42, that is compatible with other vehicle loads. In one example, the auxiliary battery 42 may be configured to power electrical accessories, lighting, ignition system and so on.

A DC/DC converter 44 is electrically connected between the traction battery 16 and the auxiliary battery 42, such as via wiring 46 and wiring 48, respectively. The DC/DC converter 44 may be a bi-directional buck-boost converter configured to convert power flowing to and from the traction battery 16 and the auxiliary battery 42. For example, in buck mode the DC/DC converter 44 may reduce (“buck”) the high voltage DC output of the traction battery 16 to low voltage DC input required by the auxiliary battery 42. In another example, the DC/DC converter 44 operating in a boost mode may increase (“boost”) the low voltage DC output of the auxiliary battery 42 to a high voltage DC input compatible with the traction battery 16.

The auxiliary battery 42 may be electrically connected to, such as via wiring 52, and configured to power an auxiliary starter motor 50. The auxiliary starter motor 50 may be configured to selectively start the engine 12, such as by engaging an engine flywheel, responsive to a signal from one or more vehicle controllers and/or sensors. In one example, the hybrid powertrain controller may be configured to command the auxiliary starter motor 50 to start the engine 12 in response to ambient temperature being below a predetermined temperature threshold, e.g., cold start. In another example, the hybrid powertrain controller may be configured to command the auxiliary starter motor 50 to start the engine 12 in response to available traction battery power being below a threshold. In still another example, the hybrid powertrain controller may be configured to command the auxiliary starter motor 50 to start the engine 12 in response to available auxiliary battery power being above a predetermined starter threshold P_{AB}_{_}_{STARTER}, e.g., an amount of power used to start the engine 12 using the auxiliary starter motor 50 under current operating conditions.

When the vehicle is operating, e.g., idling, moving, ignition in an accessory mode, and so on, available auxiliary battery power may be below a predetermined starter threshold P_{AB}_{_}_{STARTER}, such as when the auxiliary battery 42 is being used to power accessories, lighting, and other vehicle components and/or systems. Under such circumstances starting the engine 12 using the auxiliary starter motor 50 powered by the auxiliary battery 42 may affect operation of other vehicle components and/or systems already receiving power from the auxiliary battery 42. In one example, starting the engine 12 using the auxiliary starter motor 50 when available auxiliary battery power is below a predetermined starter threshold P_{AB}_{_}_{STARTER} may cause vehicle lighting system currently being powered by the auxiliary battery 42 to momentarily change brightness and so on.

In an example arrangement, the torque converter 20 may further include a torque converter clutch, e.g., a bypass clutch. The torque converter clutch may be controllable across a range between an engaged position, e.g., a lock-up position, an applied position, and so on, and a disengaged position, e.g. an unlocked position. In the engaged position, the torque converter clutch may mechanically connect the impeller and the turbine of the torque converter 20 thereby substantially disconnecting hydraulic coupling between these components. In the disengaged position, the torque converter clutch may permit the hydraulic coupling between the impeller and the turbine of the torque converter 20.

In reference to FIG. 2, an example power flow diagram 54 for starting the engine 12 using the traction battery 16 is shown. The hybrid powertrain controller may be configured to receive a signal from one or more other vehicle controllers and/or sensors indicative of a request to start the engine 12. For example, the hybrid powertrain controller may receive a signal indicative of a request to start the engine 12 from one or more other vehicle controllers and/or vehicle sensors, e.g., brake and/or accelerator pedal position sensor, crank angle sensor, and so on.

Responsive to a request, the hybrid powertrain controller may determine based on one or more vehicle operating parameters that the engine 12 may be started using energy of the traction battery 16. In one example, the hybrid powertrain controller may determine that the engine 12 may be started using energy of the traction battery 16 in response to receiving a signal indicating that one or more of engine temperature, traction battery temperature, and/or ambient temperature is above a predetermined temperature threshold. In another example, the hybrid powertrain controller may determine that the engine 12 may be started using energy of the traction battery 16 in response to receiving a signal indicating that available traction battery power is above a threshold. In still another example, the hybrid powertrain controller may determine that the engine 12 may be started using energy of the traction battery 16 in response to a signal indicating that available auxiliary battery power is below a predetermined starter threshold P_{AB}_{_}_{STARTER}.

The hybrid powertrain controller may enable the flow of energy from the traction battery 16 to the engine 12 in response to receiving a signal indicative of a request to start the engine 12. In one example, the hybrid powertrain controller, electrically connected to and in communication with the battery controller, may transmit to the battery controller a signal indicative of a request to permit energy flow from the traction battery 16. In such an example, responsive to the request, the battery controller may command one or more contactors or switches of the traction battery 16 to open or close enabling the flow of energy (illustrated generally using arrows 56-60) from the traction battery 16 to the engine 12 via the motor 14.

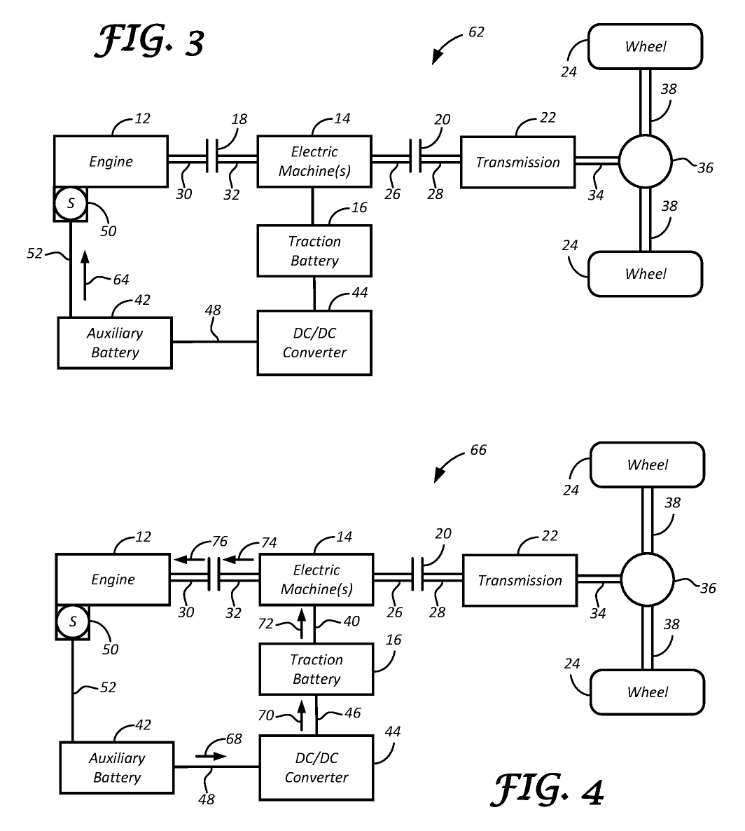

In reference to FIG. 3, an example power flow diagram 62 for starting the engine 12 using the auxiliary starter motor 50 is shown. In response to receiving a signal indicative of a request to start the engine 12, the hybrid powertrain controller may determine based on one or more vehicle operating parameters that the engine 12 may be started using energy of the auxiliary starter motor 50 powered by the auxiliary battery 42. In one example, the hybrid powertrain controller may determine that the engine 12 may be started using energy of the auxiliary starter motor 50 in response to receiving a signal indicating that one or more of engine temperature, traction battery temperature, and/or ambient temperature is below a predetermined temperature threshold, e.g., a cold start. In another example, the hybrid powertrain controller may determine that the engine 12 may be started using energy of the auxiliary starter motor 50 in response to receiving a signal indicating that available traction battery power is below a threshold. In still another example, the hybrid powertrain controller may determine that the engine 12 may be started using energy of the auxiliary starter motor 50 in response to receiving a signal indicating that available auxiliary battery power is above a predetermined starter threshold P_{AB}_{_}_{STARTER}.

The hybrid powertrain controller may enable the flow of energy from the auxiliary battery 42 to the engine 12 via the auxiliary starter motor 50 in response to determining that the engine 12 may be started using the auxiliary starter motor 50. In one example, the hybrid powertrain controller operates the auxiliary battery 42 to enable energy flow (illustrated generally using arrow 64) from the auxiliary battery 42 to the engine 12 via the auxiliary starter motor 50.

In reference to FIG. 4, an example power flow diagram 66 for starting the engine 12 using the traction and auxiliary batteries 16, 42, respectively, is shown. For example, in response to receiving a signal indicative of a request to start the engine 12, the hybrid powertrain controller may determine based on one or more vehicle operating parameters that the engine 12 may be started using energy of the traction and auxiliary batteries 16, 42. In one example, the hybrid powertrain controller may determine that the engine 12 may be started using energy of the traction and auxiliary batteries 16, 42 in response to receiving a signal indicating that one or more of engine temperature, traction battery temperature, and/or ambient temperature is below a predetermined temperature threshold. In another example, the hybrid powertrain controller may determine that the engine 12 may be started using energy of the traction and auxiliary batteries 16, 42 in response to receiving a signal indicating that available traction battery power is below a threshold. In still another example, the hybrid powertrain controller may determine that the engine 12 may be started using energy of the traction and auxiliary batteries 16, 42 in response to receiving a signal indicating that available auxiliary battery power is above a predetermined power threshold P_{AB}_{_}_{POWER}, e.g., an amount of power used to start the engine 12 using the motor 14 under current operating conditions minus an amount of available traction battery power.

When available auxiliary battery power is below a predetermined starter threshold P_{AB}_{_}_{STARTER}, such as when the vehicle is operating, e.g., idling, moving, or is in an accessory ignition mode, using the auxiliary starter motor 50 to start the engine 12 may affect operation of other vehicle components and/or systems already receiving power from the auxiliary battery 42. In such an instance, the hybrid powertrain controller may determine that the engine 12 may be started using energy of the traction and auxiliary batteries 16, 42 in response to receiving a signal indicating that available auxiliary battery power is above a predetermined power threshold P_{AB}_{_}_{POWER}.

The hybrid powertrain controller may enable the flow of energy from the traction battery 16 and the auxiliary battery 42 to the engine 12 in response to determining that the engine 12 may be started using the traction and auxiliary batteries 16, 42. In one example, the hybrid powertrain controller may transmit to the battery controller a signal indicative of a request to permit energy flow from the auxiliary battery 42 and the traction battery 16. In such an example, responsive to the request, the battery controller may operate one or more connectors or switches of the traction battery 16 to open or close enabling the flow of energy (illustrated generally using arrows 68-76) from the auxiliary battery 42 to the engine 12 via the traction battery 16.

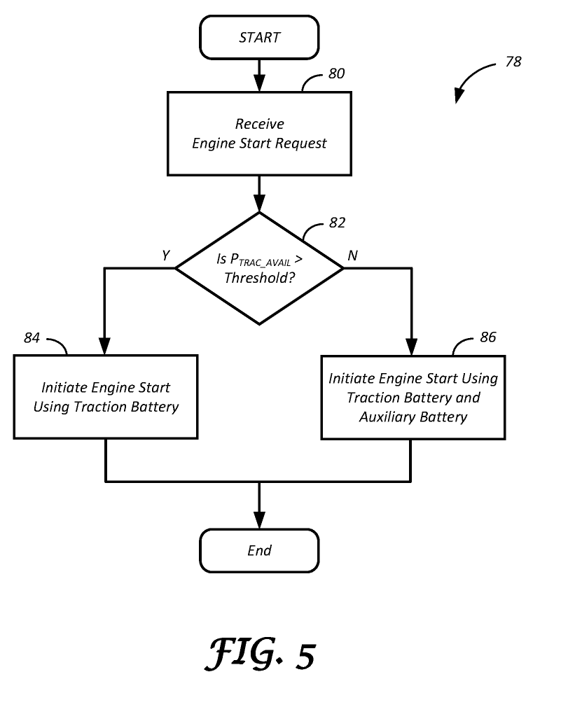

In reference to FIG. 5, a process 78 for starting the engine 12 using the traction battery 16 and the auxiliary battery 42 is shown. The process 78 may begin at block 80 where the hybrid powertrain controller receives a signal indicative of a request to start the engine 12. For example, the hybrid powertrain controller may receive a signal indicative of a request to start the engine 12 from one or more other vehicle controllers and/or battery and vehicle sensors, e.g., brake and/or accelerator pedal position sensor, crank angle sensor, clutch position sensor, and so on.

At block 82 the hybrid powertrain controller may determine whether available traction battery power is above a threshold. In one example, the hybrid powertrain controller may determine available traction battery power based on one or more vehicle operating conditions and/or operating parameters that may influence available traction battery power. The one or more vehicle operating conditions and operating parameters may be, but are not limited to, ambient temperature, traction battery temperature, engine temperature, engine off time, and so on. In an example, the hybrid controller may determine whether available traction battery power is above a threshold based on amount of power or energy that may be used to start the engine 12 under particular operating conditions.

At block 84 the hybrid powertrain controller may initiate starting of the engine 12 using energy of the traction battery 16 in response to determining at block 82 that available battery power is above a threshold. In one example, the hybrid powertrain controller may transmit to the battery controller a signal indicative of a request to enable energy flow from the traction battery 16 to the engine 12 via the motor 14. The process 78 may then end.

At block 86 the hybrid powertrain controller may initiate starting of the engine 12 using energy of the traction battery 16 and the auxiliary battery 42 in response to determining at block 82 that available traction battery power is below a threshold. As described in reference to FIG. 4 the hybrid powertrain controller may transmit to the battery controller a signal indicative of a request to permit energy flow from the auxiliary battery 42 and the traction battery 16. Responsive to the request, the battery controller may operate to open or close one or more contactors or switches of the traction battery 16 enabling the flow of energy from the auxiliary battery 42 to the engine 12 via the traction battery 16. The process 78 may then end. In some embodiments, the process 78 may be repeated in response to receiving a request to start the engine 12 or another request.

The processes, methods, or algorithms disclosed herein may be deliverable to or implemented by a processing device, controller, or computer, which may include any existing programmable electronic control unit or dedicated electronic control unit. Similarly, the processes, methods, or algorithms may be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms may also be implemented in a software executable object. Alternatively, the processes, methods, or algorithms may be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

The words used in the specification are words of description rather than limitation, and it is understood that various changes may be made without departing from the spirit and scope of the disclosure. As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A system for a vehicle comprising:
an electric machine configured to transfer power between an engine and traction battery;
an auxiliary battery electrically connected with and isolated from the traction battery; and
a controller programmed to, after receiving an engine start request,
initiate an engine start using the batteries in response to available traction battery power being below a threshold, and
initiate the engine start using the traction battery but not the auxiliary battery otherwise.

2. The system of claim 1, wherein initiating the start using the batteries includes initiating a transfer of auxiliary battery power to the traction battery.

3. The system of claim 1, wherein the controller is further programmed to obtain the available traction battery power while the vehicle is operating.

4. A system for a vehicle comprising:
an electric machine configured to be selectively coupled to an engine via a clutch;
traction and auxiliary batteries electrically isolated from each other; and
a controller programmed to, in response to receiving an engine start request while available traction battery power is below a threshold, operate the traction and auxiliary batteries at a same time to power the electric machine to start the engine.

5. The system of claim 4, wherein the operating includes transferring auxiliary battery power to the traction battery.

6. The system of claim 4, wherein the controller is further programmed to operate the traction and auxiliary batteries at a same time to power the electric machine to start the engine in further response to receiving the engine start request while ambient temperature is below a temperature threshold.

7. The system of claim 4, wherein the controller is further programmed to obtain the available traction battery power while the vehicle is operating.

8. The system of claim 4, wherein the controller is further programmed to operate the traction and auxiliary batteries at a same time to power the electric machine to start the engine in further response to available auxiliary battery power being above a power threshold.

9. The system of claim 8, wherein the controller is further programmed to operate the traction and auxiliary batteries at a same time to power the electric machine to start the engine in further response to available auxiliary battery power being below a starter threshold.

10. The system of claim 4, wherein the controller is further programmed to operate the traction battery but not the auxiliary battery to power the electric machine to start the engine in response to available auxiliary battery power being below a power threshold.

11. The system of claim 4, wherein the controller is further programmed to operate the auxiliary battery to power an auxiliary starter motor mechanically connected to the engine to start the engine in response to available traction battery power being below the threshold and available auxiliary battery power being above a starter threshold.

12. A method for a vehicle comprising:
after receiving an engine start request, initiating by a controller an engine start using a traction battery and an auxiliary battery electrically connected with and isolated from the traction battery in response to available traction battery power being below a threshold, and initiating the engine start using the traction battery but not the auxiliary battery otherwise.

13. The method of claim 12, wherein the initiating the start using the traction battery and the auxiliary battery includes initiating a transfer of auxiliary battery power to the traction battery.

14. The method of claim 12, wherein the available traction battery power is obtained while the vehicle is operating.
